(19) United States
(12) Patent Application Publication
(10) Pub. No.: US 2010/0245297 A1
(43) Pub. Date: Sep. 30, 2010

(54) Electronic Paper Display Device

(76) Inventor: Cheng-Hao Lee, Hsinchu (TW)

Correspondence Address: LanWay IPR Services, P.O. Box 220746, Chantilly, VA, 20153, US

(21) Appl. No.: 12/465,091

(22) Filed: May 13, 2009

(30) Foreign Application Priority Data
Mar. 30, 2009 (TW) 098110538

(51) Int. Cl. G09G 5/00

(52) U.S. Cl. 345/204

(57) ABSTRACT

An electronic paper display device includes an electronic paper display panel and a flexible substrate. The electronic paper display panel has a first side and a second side adjacent to the first side, wherein a length of the first side is shorter than a length of the second side. Further, the flexible substrate is connected with the first side of the electronic paper display panel. The electronic paper display device can meet different application requirements.

### CROSS-REFERENCE TO RELATED APPLICATIONS

This application is based upon and claims the benefit of priority from the prior Taiwanese Patent Application No. 098110538, filed Mar. 30, 2009, the entire contents of which are incorporated herein by reference.

### BACKGROUND

1. Field of the Invention

The present invention relates to a display device, and particularly to an electronic paper display device.

2. Description of the Related Art

Recently, flat display devices have gradually become mainstream display devices. In the situation that the environmental issue is getting more and more important, application of the electronic paper display device is more and more popular due to the electronic paper display device having a feature of saving power. Among various kinds of the electronic paper display devices, the electrophoretic display device is more popular. The electrophoretic display device is usually applied to portable electronic apparatuses such as mobile phone, electronic book device, digital photo frame, personal digital assistant, etc. to reduce power consumption of the portable electronic apparatuses.

FIG. 1 is a schematic view of a conventional electrophoretic display device. Referring to FIG. 1, the conventional electrophoretic display device 100 includes an electrophoretic display panel 110 and a flexible printed circuit board (FPCB) 120. The electrophoretic display panel 110 has a display area 112 and a peripheral circuit area 114. Moreover, the electrophoretic display panel 110 has two opposite long sides 116 and two opposite short sides 118. The FPCB 120 is connected to one of the long sides of the electrophoretic display panel 110 and electrically connected to the peripheral circuit area 114 through a contact end 122 of the FPCB 120. Further, a contact end 124 of the FPCB 120 is adapted to be electrically connected to a drive circuit board of a portable electronic apparatus (not shown), such that the drive circuit board is capable of driving the electrophoretic display panel 110 to display images.

The portable electronic apparatus is developed to achieve compact size, so internal space of the portable electronic apparatus usually is not large and utilization ratio of the internal space is usually high. In the conventional technique, the FPCB 120 is always connected to the long side 116 of the electrophoretic display panel 110, and when the electrophoretic display device 100 is applied to some portable electronic apparatuses, it is common that the electrophoretic display device 100 is not easily put into the internal space of the portable electronic apparatus. Such that, a layout of internal elements of the portable electronic apparatus should be changed or the size of the portable electronic apparatus should be increased to let the electrophoretic display device 100 can be put in the portable electronic apparatus.

### BRIEF SUMMARY

The present invention provides an electronic paper display device to meet different application requirements.

To achieve the abovementioned advantages, the present invention provides an electronic paper display device including an electronic paper display panel and a flexible substrate. The electronic paper display panel has a first side and a second side adjacent to the first side, wherein a length of the first side is shorter than a length of the second side. Further, the flexible substrate is connected with the first side of the electronic paper display panel.

In an embodiment of the present invention, the electronic paper display panel is an electrophoretic display panel.

In an embodiment of the present invention, the electronic paper display panel is an electrowetting display panel.

In an embodiment of the present invention, the electronic paper display panel is a cholesterol liquid crystal display panel.

In an embodiment of the present invention, the flexible substrate is an FPCB.

In the electronic paper display device of the present invention, due to the first side connected with the flexible substrate being a short side of the electronic paper display panel, when the electronic paper display device is applied to some portable electronic apparatuses, the electronic paper display device can be easily assembled in the portable electronic apparatus without changing a layout of internal elements of the portable electronic apparatus or increasing a size of the portable electronic apparatus. Therefore, the electronic paper display device of present invention can meet different application requirements.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view of a conventional electrophoretic display device.

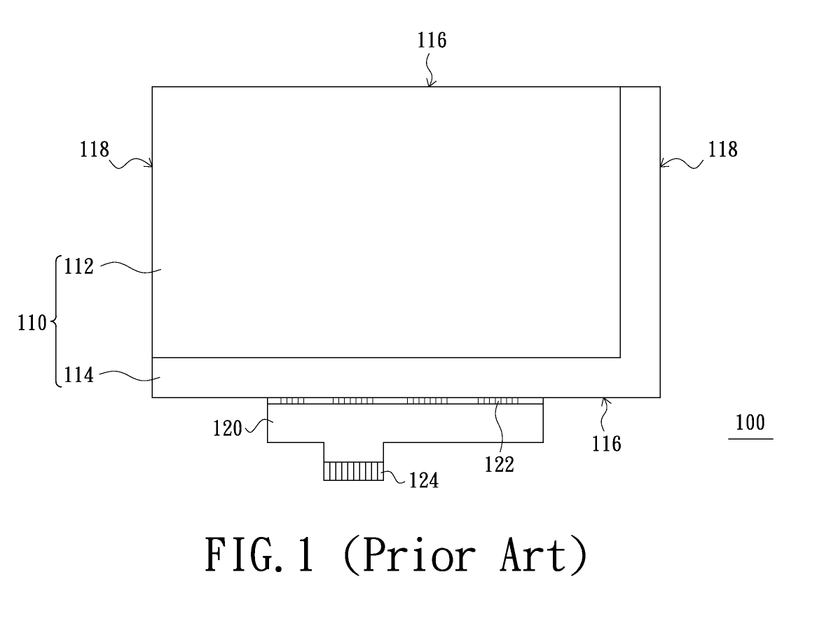

FIG. 2 is a schematic view of an electronic paper display device according to an embodiment of the present invention.

FIG. 3 is a schematic view of an electronic paper display device according to another embodiment of the present invention.

### DETAILED DESCRIPTION

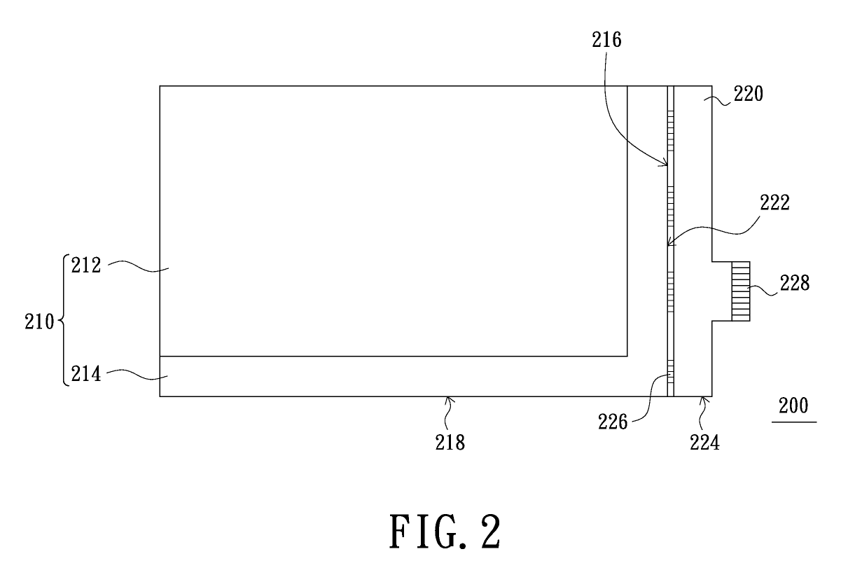

FIG. 2 is a schematic view of an electronic paper display device according to an embodiment of the present invention. Referring to FIG. 2, the electronic paper display device 200 of the present embodiment includes an electronic paper display panel 210 and a flexible substrate 220. The electronic paper display panel 210 has a display area 212 and a peripheral circuit area 214 beside the display area 212. Further, the electronic paper display panel 210 has a first side 216 and a second side 218 adjacent to the first side 216, wherein the first side 216 is located beside the peripheral circuit area 214, and a length of the first side 216 is shorter than a length of the second side 218. Moreover, the flexible substrate 220 is connected with the first side 216 of the electronic paper display panel 210 and is electrically connected with the peripheral circuit area 214.

A shape of the electronic paper display panel 210 can be rectangular. Moreover, the electronic paper display panel 210 can be an electrophoretic display panel, an electrowetting display panel, a cholesterol liquid crystal display panel or other bi-stable display panel.

The flexible substrate 220 is, for example, an FPCB. The flexible substrate 220 has a third side 222 and a fourth side 224 adjacent to the third side 222, wherein a touch end 226 is formed on the third side 222 for being electrically connected to the peripheral circuit area 214 of the electronic paper display panel 210. Moreover, a touch end 228 of the flexible substrate 220 is adapted to be electrically connected to an external driving circuit board such as a driving circuit board of a portable electronic apparatus, and such that the external driving circuit board can be capable of driving the electronic paper display panel 210 to display images. Furthermore, in the present embodiment, the length of the first side 216 of the electronic paper display panel 210 is, for example, equal to that of the third side 222 of the flexible substrate 220.

Due to the conventional electronic paper display device being not easily assembled in some portable electronic apparatuses, a layout of internal elements of the portable electronic apparatus should be changed or a size of the portable electronic apparatus should be increased. In view of this, the flexible substrate 220 of the electronic paper display device 200 of the present embodiment is connected with a short side (i.e. the first side 216) of the electronic paper display panel 210. Such that, when the electronic paper display device 200 is applying to some portable electronic apparatuses, the electronic paper display device 200 can be easily assembled in the portable electronic apparatus without changing the layout of the internal elements of the portable electronic apparatus or increasing the size of the portable electronic apparatus. Therefore, the electronic paper display device 200 of the present embodiment can meet different application requirements.

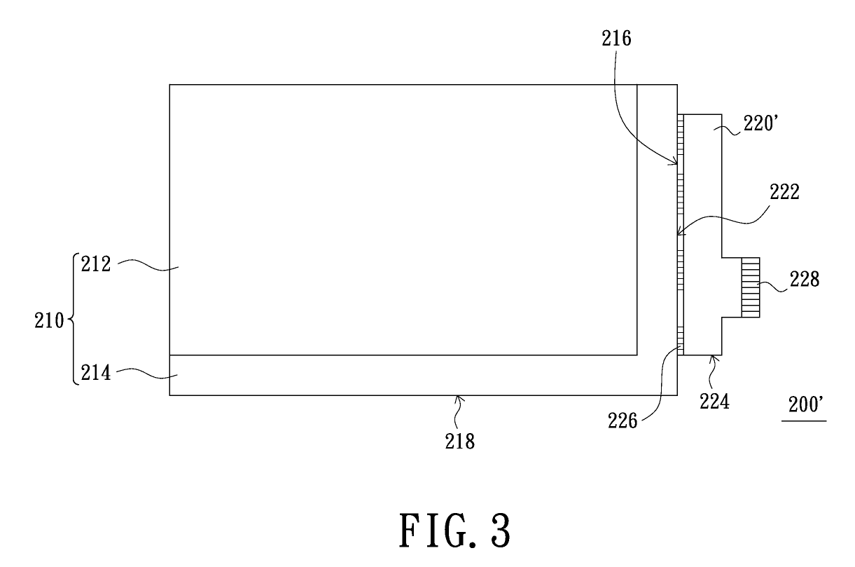

FIG. 3 is a schematic view of an electronic paper display device according to another embodiment of the present invention. Referring to FIG. 3, the electronic paper display device 200′ of the present embodiment is similar to the electronic paper display device 200 of FIG. 2, the difference is that the length of the third side 222 of the flexible substrate 220′ of the electronic paper display device 200′ is shorter than the length of the first side 216 of the electronic paper display panel 210. A structure strength of a connection portion between the electronic paper display panel 210 and the flexible substrate 220′ is weaker, and this may cause a bad connection between the electronic paper display panel 210 and the flexible substrate 220′. Thus, the length of the third side 222 of flexible substrate 220′ of the present embodiment is designed to be the shorter than the length of the first side 216 of the electronic paper display panel 210 to reduce an area of the connection portion between the electronic paper display panel 210 and the flexible substrate 220′. Such that, the area of the connection portion having weak structure strength is reduced to reduce occurrence probability of bad connection. Therefore, reliability of the electronic paper display device 200′ is improved.

Comparing to the flexible substrate 220, due to the length of the third side 222 of the flexible substrate 220′ being shorten, the length of the fourth side 224 of the flexible substrate 220′ can be increased to enable the flexible substrate 220′ to have enough area for circuit layout.

In summary, the electronic paper display device of the present invention has at least the following advantages:

1. Comparing to the conventional technique, due to the first side connected with the flexible substrate being a short side of the electronic paper display panel, the electronic paper display device of the present invention can meet different application requirements.

2. Reducing the area of the connection portion between the flexible substrate and the electronic paper display panel can improve the reliability of the electronic paper display device of the present invention.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An electronic paper display device comprising:
an electronic paper display panel having a first side and a second side adjacent to the first side, wherein a length of the first side is shorter than a length of the second side; and
a flexible substrate connected with the first side of the electronic paper display panel.

2. The electronic paper display device as claimed in claim 1, wherein the electronic paper display panel is an electrophoretic display panel.

3. The electronic paper display device as claimed in claim 1, wherein the electronic paper display panel is an electrowetting display panel.

4. The electronic paper display device as claimed in claim 1, wherein the electronic paper display panel is a cholesterol liquid crystal display panel.

5. The electronic paper display device as claimed in claim 1, wherein the flexible substrate is a flexible printed circuit board.
